(19) United States
(12) Patent Application Publication
(10) Pub. No.: US 2026/0163311 A1
(43) Pub. Date: Jun. 11, 2026

(54) PANEL MOUNT CONNECTOR

(71) Applicant: SUMITOMO WIRING SYSTEMS, LTD., Mie (JP)

(72) Inventor: Kenkichi KAI, Mie (JP)

(21) Appl. No.: 19/404,385

(22) Filed: Dec. 1, 2025

(30) Foreign Application Priority Data
Dec. 6, 2024 (JP) 2024-213349

(51) Int. Cl. H01R 13/74

(52) U.S. Cl. CPC H01R 13/74

(57) ABSTRACT

A panel mount connector includes a temporary holding mechanism for temporarily holding a first connector holder in a hole portion of a panel before a second connector holder is fit to the first connector holder, a releasing mechanism for releasing the temporary holding mechanism in a process of fitting the second connector holder to the first connector holder, and a complete locking mechanism for completely locking the second connector holder fit to the first connector holder in the hole portion of the panel. The temporary holding mechanism includes a first rattling suppressing portion for suppressing rattling by being located in a gap between the first connector holder temporarily held in the hole portion of the panel and the hole portion.

### CROSS-REFERENCE TO RELATED APPLICATIONS

This application is based on and claims priority from Japanese Patent Application No. 2024-213349, filed on December 6, 2024, with the Japan Patent Office, the disclosure of which is incorporated herein in its entirety by reference.

### TECHNICAL FIELD

The present invention relates to a panel mount connector.

### BACKGROUND

Conventionally, a connector is known which is provided with a first connector housing to be held on a panel by locking a resiliently deformable locking arm into a hole of the panel when the first connector housing is passed through the hole and a second connector housing configured to unlock the locking arm and be locked to the panel, instead of the first connector housing, when the first connector housing is connected to the second connector housing. The first connector housing assumes a standby state to be held in the hole of the panel by the locking arm before the second connector housing is connected.

When the first connector housing is inserted into the hole of the panel and locked in the hole, a predetermined amount of rattling is present between the first connector housing and the hole of the panel. This is for confirming whether or not the locking arm of the first connector housing is properly locked in the hole of the panel by pulling the first connector housing in a direction opposite to an insertion direction into the panel after the first connector housing is mounted into the hole of the panel.

The first connector housing is not necessarily pulled straight in the direction opposite to the insertion direction, but may be, for example, pulled obliquely to the direction opposite to the insertion direction. At this time, if a pulling force in an oblique direction is large, a large deformation load is applied to the locking arm in a direction intersecting a resilient deformation direction. Thus, a torsional stress is generated in the locking arm. Therefore, there has been a possibility that the locking arm is deformed or damaged. If the locking arm is deformed or damaged, the amount of rattling between the first connector housing and the hole of the panel increases. Thus, it has been necessary to suppress the deformation and damage of the locking arm to stably hold the first connector housing on the panel.

Accordingly, in Japanese Patent No. 4949936, a displacement restricting means (specifically, a rib) for restricting a displacement of the locking arm in a direction intersecting the resilient deformation direction of the locking arm is provided near the locking arm in the first connector housing. Thus, even if an excessive load is applied to the locking arm in the direction intersecting the resilient deformation direction by strongly pulling the first connector housing in an oblique direction, deformation caused by that load is restricted by the rib, wherefore excessive torsional deformation of the locking arm is suppressed. In this way, the locking arm is hardly deformed or damaged.

### SUMMARY

In Japanese Patent No. 4949936, excessive deformation of the locking arm is suppressed by a structure for directly bringing the locking arm into contact with the rib to suppress rattling between the first connector housing and the hole of the panel. Thus, in the case of Japanese Patent No. 4949936, the rib sized to be capable of withstanding the direct contact with the locking arm needs to be newly provided in the first connector housing. Therefore, a space for arranging the rib having a certain size is necessary. This has hindered the simplification of the structure of the first connector housing.

Further, also when the second connector housing is locked in the hole of the panel, it is required to suppress rattling between the second connector housing and the hole of the panel. A state where the second connector housing is locked to the panel is a state where the mounting of the connector on the panel is completed. Thus, if a position in this state can be stabilized, it leads to an improvement in reliability. Also in this case, it is highly necessary to suppress the rattling by a simple structure, similarly to the first connector housing.

The present disclosure aims to provide a panel mount connector capable of suppressing rattling between a panel and the panel mount connector by a simple configuration.

A panel mount connector for solving the above problem is used by mounting a second connector having a first connector connected thereto into a hole portion of a panel, and provided with a temporary holding mechanism for temporarily holding a first connector holder in the hole portion of the panel before a second connector holder of the second connector is fit to the first connector holder of the first connector, a releasing mechanism for releasing the temporary holding mechanism in a process of fitting the second connector holder to the first connector holder, and a complete locking mechanism for completely locking the second connector holder in the hole portion of the panel by moving the second connector holder to a complete locking position together with the first connector holder released from temporary holding, the temporary holding mechanism including a first rattling suppressing portion for suppressing rattling by being located in a gap between the first connector holder temporarily held in the hole portion of the panel and the hole portion, and the complete locking mechanism including a second rattling suppressing portion for suppressing rattling by being located in a gap between the second connector holder completely locked in the hole portion of the panel and the hole portion.

The present disclosure can suppress rattling between a panel mount connector and a panel by a simple configuration.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a panel mount connector in a temporarily held state according to one embodiment.

FIG. 2 is a perspective view of the panel mount connector in a completely held state.

FIG. 3A is a perspective view of a temporary holding mechanism in a state where a temporary holding projection is not pressed and FIG. 3B is a perspective view of the temporary holding mechanism in a state where the temporary holding projection is pressed.

FIG. 4 is an exploded perspective view of the panel mount connector viewed from one side.

FIG. 5 is an exploded perspective view of the panel mount connector viewed from the other side.

FIG. 6 is an exploded perspective view showing the structure of cam mechanisms.

FIGS. 7A to 7C are diagrams showing a state transition when a second connector holder is completely fit to a first connector holder by a lever operation.

FIG. 8 is a perspective view showing the inner shape of the second connector holder.

FIG. 9 is a perspective view showing the outer shape of the second connector holder.

FIGS. 10A and 10B are perspective views showing an operation flow of a releasing mechanism.

FIG. 11A is a front view of a complete locking mechanism in a state where a complete locking projection is not pressed, and FIG. 11B is a front view of the complete locking mechanism in a state where the complete locking projection is pressed.

FIGS. 12A to 12C are diagrams showing a state transition when the complete locking projection of the complete locking mechanism is locked to a panel.

FIGS. 13A to 13C are action diagrams of a first rattling suppressing portion.

FIG. 14 is a side view showing a state where the first connector holder in the temporarily held state is pulled by a wire group.

FIGS. 15A and 15B are action diagrams of a second rattling suppressing portion.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

First, embodiments of the present disclosure are listed and described.

[1] The panel mount connector of the present disclosure is used by mounting a second connector having a first connector connected thereto into a hole portion of a panel, and provided with a temporary holding mechanism for temporarily holding a first connector holder in the hole portion of the panel before a second connector holder of the second connector is fit to the first connector holder of the first connector, a releasing mechanism for releasing the temporary holding mechanism in a process of fitting the second connector holder to the first connector holder, and a complete locking mechanism for completely locking the second connector holder in the hole portion of the panel by moving the second connector holder to a complete locking position together with the first connector holder released from temporary holding, the temporary holding mechanism including a first rattling suppressing portion for suppressing rattling by being located in a gap between the first connector holder temporarily held in the hole portion of the panel and the hole portion, and the complete locking mechanism including a second rattling suppressing portion for suppressing rattling by being located in a gap between the second connector holder completely locked in the hole portion of the panel and the hole portion.

According to this configuration, since it is sufficient to provide the first rattling suppressing portion shaped to fill the gap between the first connector holder temporarily held in the hole portion of the panel and the hole portion of the panel, rattling between these can be suppressed by the simply shaped first rattling suppressing portion. Thus, the structure of the first connector holder can be simplified. Further, since it is sufficient to provide the second rattling suppressing portion shaped to fill the gap between the second connector holder completely locked in the hole portion of the panel and the hole portion of the panel, rattling between these can be suppressed by the simply shaped second rattling suppressing portion. Thus, the structure of the second connector holder can be simplified.

[2] In [1] described above, the panel mount connector is provided with a lever provided on the second connector holder operably from an initial position to a connection position and a cam mechanism for completely fitting the second connector holder to the first connector holder by converting an operation direction of the lever into a fitting direction of the second connector holder in a process of operating the lever from the initial position to the connection position, and the releasing mechanism releases the temporary holding mechanism in a process of completely fitting the second connector holder to the first connector holder by an operation of the lever to the connection position. According to this configuration, the temporary holding mechanism can be released in conjunction with a completely fitting operation of the first and second connector holders by a lever operation. Thus, workability can be improved as compared to the case where these are performed by separate operations.

[3] In [1] or [2] described above, the first rattling suppressing portion has a temporary holding guide slope for guiding insertion of the first connector holder into the hole portion when the first connector holder is inserted into the hole portion and temporarily held on the panel and a temporary holding contact flat surface for suppressing rattling between the hole portion and the first connector holder by coming into surface contact with an inner surface of the hole portion when the first connector holder is temporarily held in the hole portion of the panel. According to this configuration, since the insertion is guided by the temporary holding guide slope of the first rattling suppressing portion when the first connector holder is inserted into the hole portion of the panel, the first connector holder can be smoothly mounted on the panel. Further, since the first connector holder temporarily held in the hole portion of the panel is supported by the temporary holding contact flat surface of the first rattling suppressing portion, the first connector holder is held in the hole portion by a stable holding force by the flat surface. Thus, rattling can be made difficult to occur between the first connector holder and the hole portion of the panel by the simply shaped flat surface.

[4] In [3] described above, the temporary holding mechanism includes a resiliently deformable temporary holding projection for temporarily holding the first connector holder in the hole portion by being engaged with the hole portion of the panel by a resilient force, and the first rattling suppressing portions are formed on both sides across the temporary holding projection. According to this configuration, since the first rattling suppressing portions are provided on the both sides of the temporary holding projection, the stability of the first connector holder temporarily held in the hole portion of the panel is improved. This further contributes to the rattling suppression of the first connector holder with respect to the panel.

[5] In [4] described above, the first connector holder includes a receptacle having an outer surface to be held in contact with the hole portion of the panel, the second connector holder being accommodated inside the receptacle, and the temporary holding projection and the first rattling suppressing portions are arranged on each of facing walls located at an opening of the receptacle. According to this configuration, when the first connector holder is temporarily held in the hole portion of the panel, the temporary holding projections are arranged on the both sides when viewed in an insertion direction of the first connector holder into the panel. Thus, the first connector holder can be held on the panel in a well-balanced manner. Similarly, since the first rattling suppressing portions are also arranged on the both sides, rattling can also be suppressed in a well-balanced manner. This further contributes to the rattling suppression of the first connector holder with respect to the panel.

[6] In any one of [1] to [5] described above, the second rattling suppressing portion has a complete locking guide slope for guiding insertion of the second connector holder into the hole portion when the second connector holder fit to the first connector holder is inserted into the hole portion and completely locked to the panel, and a complete locking contact flat surface for suppressing rattling between the hole portion and the second connector holder by coming into surface contact with an inner surface of the hole portion when the second connector holder is completely locked in the hole portion of the panel. According to this configuration, when the second connector holder fit to the first connector holder is inserted into the hole portion of the panel, the insertion is guided by the complete locking guide slope of the second rattling suppressing portion, wherefore the second connector holder can be smoothly mounted on the panel. Further, since the second connector holder completely locked in the hole portion of the panel is supported by the complete locking contact flat surface of the second rattling suppressing portion, the second connector holder is held in the hole portion by a stable holding force by the flat surface. Therefore, rattling can be made difficult to occur between the second connector holder and the hole portion of the panel by the simply shaped flat surface.

[7] In [6] described above, the complete locking mechanism includes a resiliently deformable complete locking projection for completely locking the second connector holder in the hole portion by being engaged with the hole portion of the panel by a resilient force, and the second rattling suppressing portions are formed on both sides across the complete locking projection. According to this configuration, since the second rattling suppressing portions are provided on the both sides of the complete locking projection, the stability of the second connector holder completely locked in the hole portion of the panel is improved. This further contributes to the rattling suppression of the second connector holder with respect to the panel.

### Details of Embodiment of Present Disclosure

A specific example of the present disclosure is described below with reference to the drawings. Note that the present disclosure is not limited to these illustrations, but is represented by claims and intended to include all changes in the scope of claims and in the meaning and scope of equivalents. For the convenience of description, some components may be shown in an exaggerated or simplified manner in each drawing. Further, a dimension ratio of each part may be different from the actual one.

### Panel Mount Connector 1

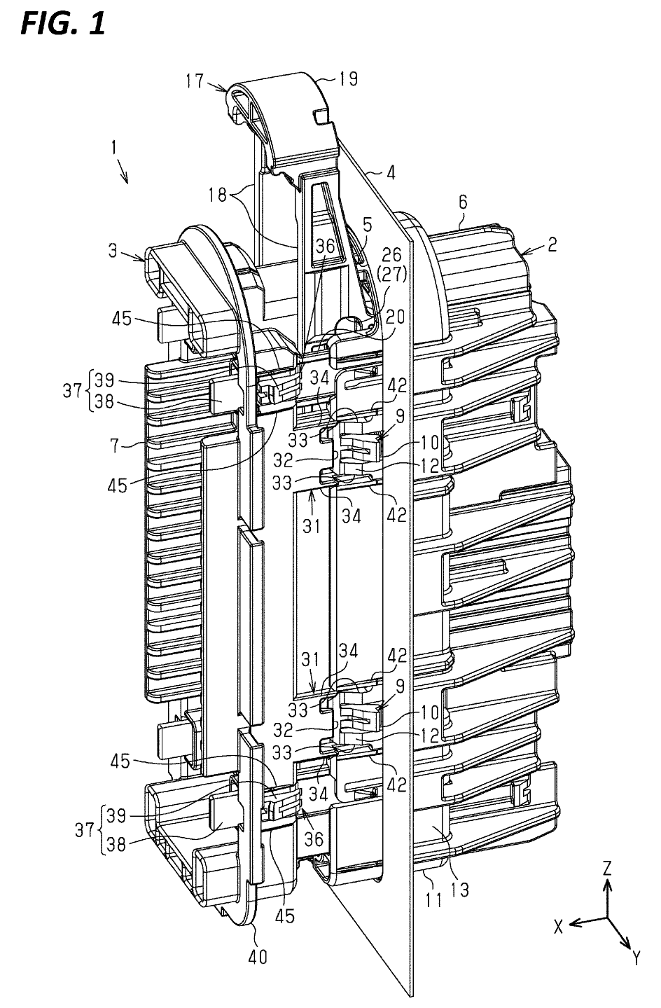

As shown in FIG. 1, a panel mount connector 1 is provided with a first connector 2 including one or more terminals (not shown) and a second connector 3 including terminal(s) (not shown) to be electrically connected to the terminal(s) of the first connector 2. A mounting destination of an assembly formed by connecting the first and second connectors 2, 3 is a plate-like panel 4. The assembly formed by connecting the first and second connectors 2, 3 is inserted and mounted into a hole portion 5 of the panel 4. The panel mount connector 1 is, for example, used in a vehicle.

One of the first and second connectors 2, 3 is a male connector, and the other is a female connector. In the case of this example, the first connector 2 is a male connector and the second connector 3 is a female connector. In the first connector 2, sub connectors (not shown) having the terminals mounted therein are accommodated inside a hollow first connector holder 6. In the second connector 3, sub connectors (not shown) having the terminals mounted therein are accommodated inside a hollow second connector holder 7. The panel 4 is a member partitioning the inside and outside of the vehicle and, for example, a door panel.

### Temporary Holding Mechanisms 9

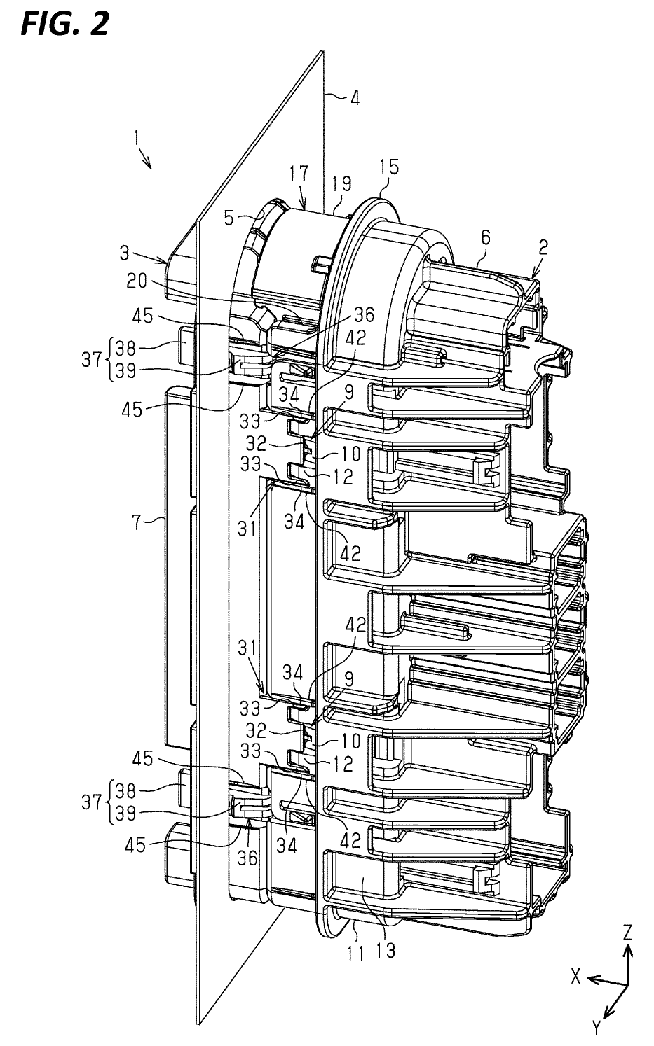

As shown in FIGS. 1 and 2, the panel mount connector 1 is provided with temporary holding mechanisms 9 for temporarily holding the first connector holder 6 of the first connector 2 in the hole portion 5 of the panel 4. The temporary holding mechanisms 9 temporarily hold the first connector holder 6 in the hole portion 5 of the panel 4 before the second connector holder 7 is fit to the first connector holder 6. When the second connector 3 is connected to the first connector 2 temporarily held on the panel 4 (state of FIG. 1), temporary holding is released and the first connector 2 becomes movable in a depth direction (-X-axis direction of FIG. 1) together with the second connector 3 when the first and second connectors 2, 3 are completely connected. If these are moved in the depth direction, the second connector 3 is fixed to the panel 4, instead of the first connector 2 (state of FIG. 2). In this way, the panel mount connector 1 of this example is used by mounting the second connector 3 having the first connector 2 connected thereto into the hole portion 5 of the panel 4.

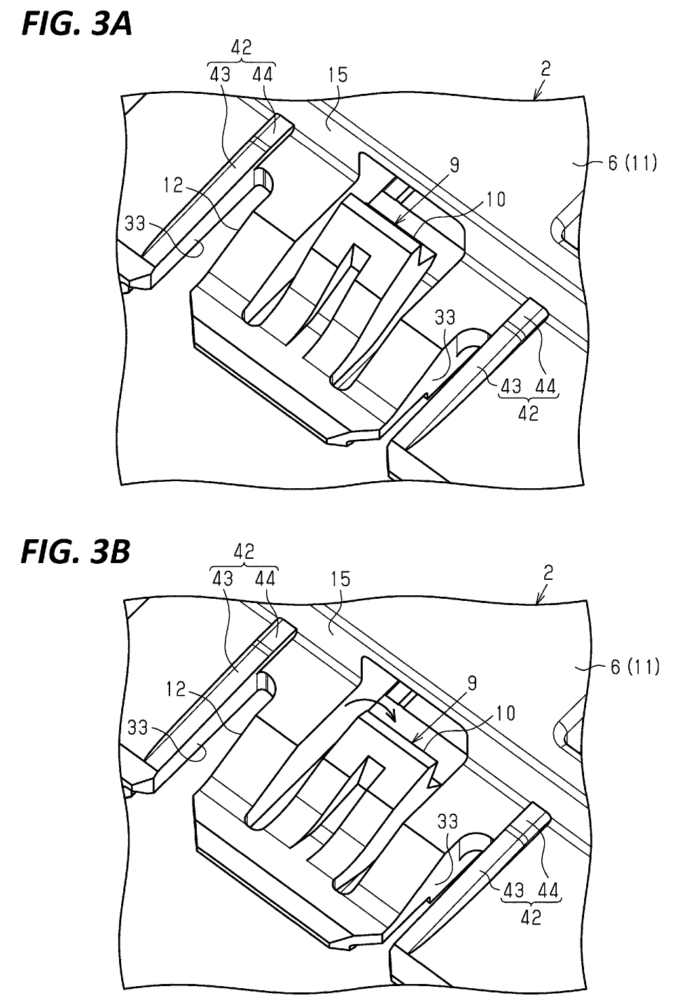

As shown in FIGS. 3A and 3B, the temporary holding mechanism 9 includes a temporary holding projection 10 formed to be resiliently deformable to be engaged with the hole portion 5 of the panel 4. The temporary holding projection 10 is for retaining the first connector holder 6 on the panel 4, and shaped to include a projection on the tip of a resiliently deformable arm having a fixed base end. The temporary holding projection 10 is, for example, formed to be resiliently deformable with the base end as a center in a substantially U-shaped base portion 12 formed on the tip of a receptacle 11 of the first connector holder 6. The temporary holding projection 10 temporarily holds the first connector holder 6 in the hole portion 5 by being engaged with the hole portion 5 of the panel 4 by a resilient force.

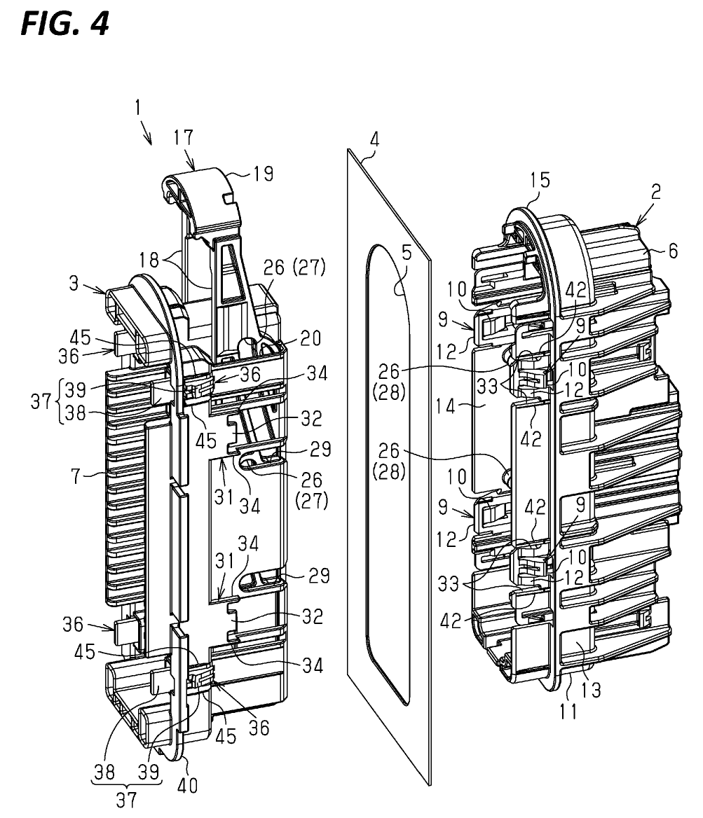

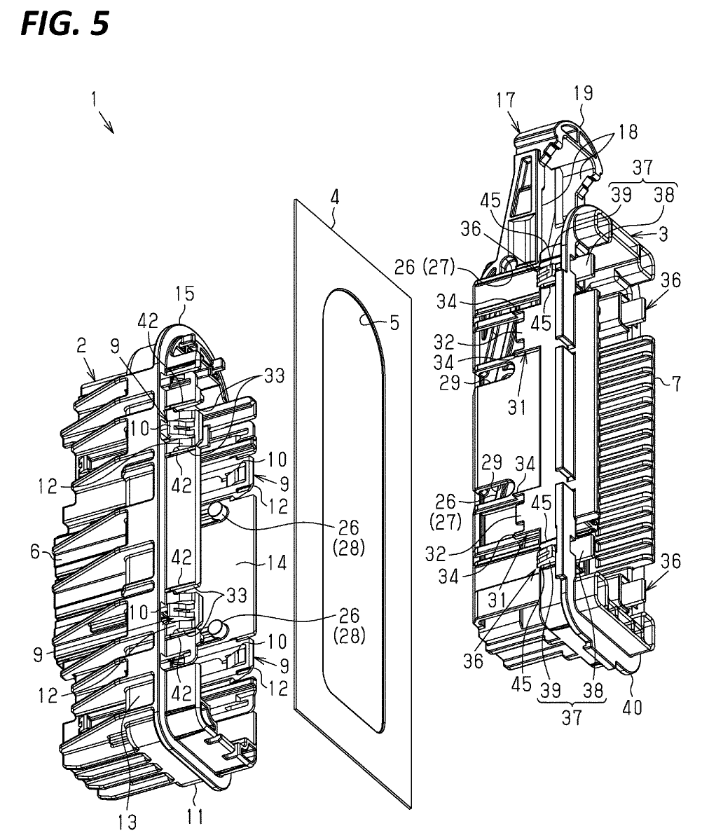

As shown in FIGS. 4 and 5, the first connector holder 6 is, for example, formed into a substantially rectangular parallelepiped shape having straight long sides and substantially arcuate short sides. The first connector holder 6 includes the receptacle 11 to be fit to the second connector holder 7. The receptacle 11 includes a pair of facing walls 13, 14 on the straight long sides of the first connector holder 6.

The temporary holding projections 10 are arranged on each of the facing walls 13, 14 located on the tip of the receptacle 11. In the case of this example, two temporary holding projections 10 are formed on each of the facing walls 13, 14. A flange 15 for restricting an insertion amount of the first connector holder 6 when the first connector holder 6 is inserted into the hole portion 5 is formed in a circumferential direction on the outer peripheral surface of the receptacle 11. After the first connector holder 6 is temporarily held on the panel 4 by the temporary holding projections 10, any further insertion of the first connector holder 6 is restricted by the interference of the flange 15 with the panel 4 even if the first connector holder 6 is further inserted.

### Complete Connection of Connector

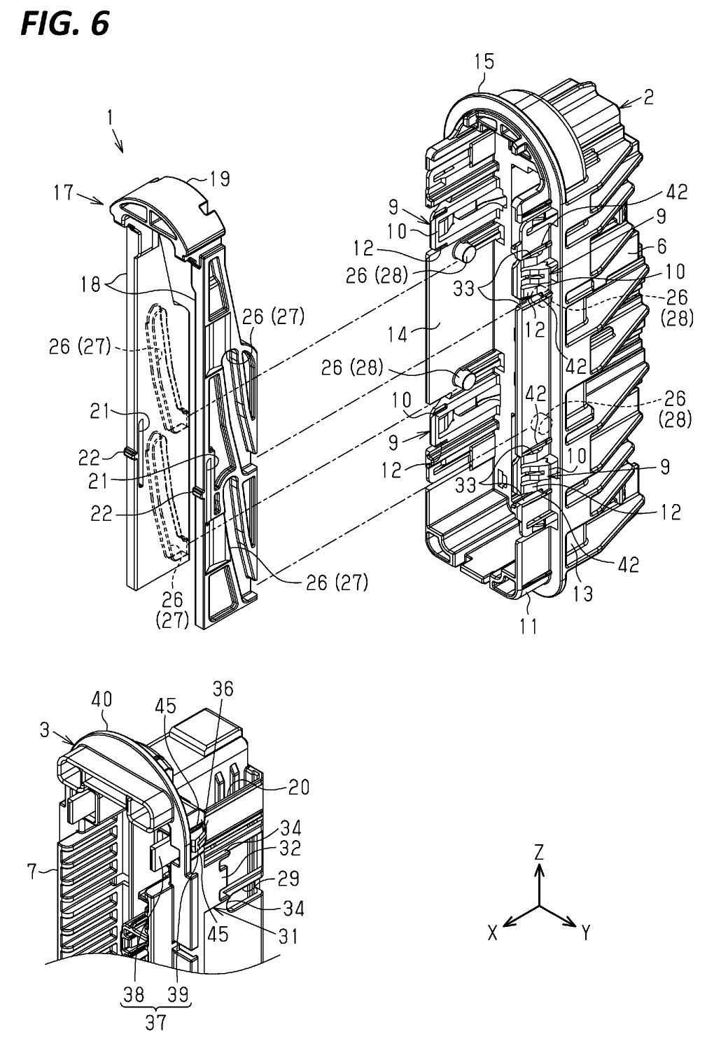

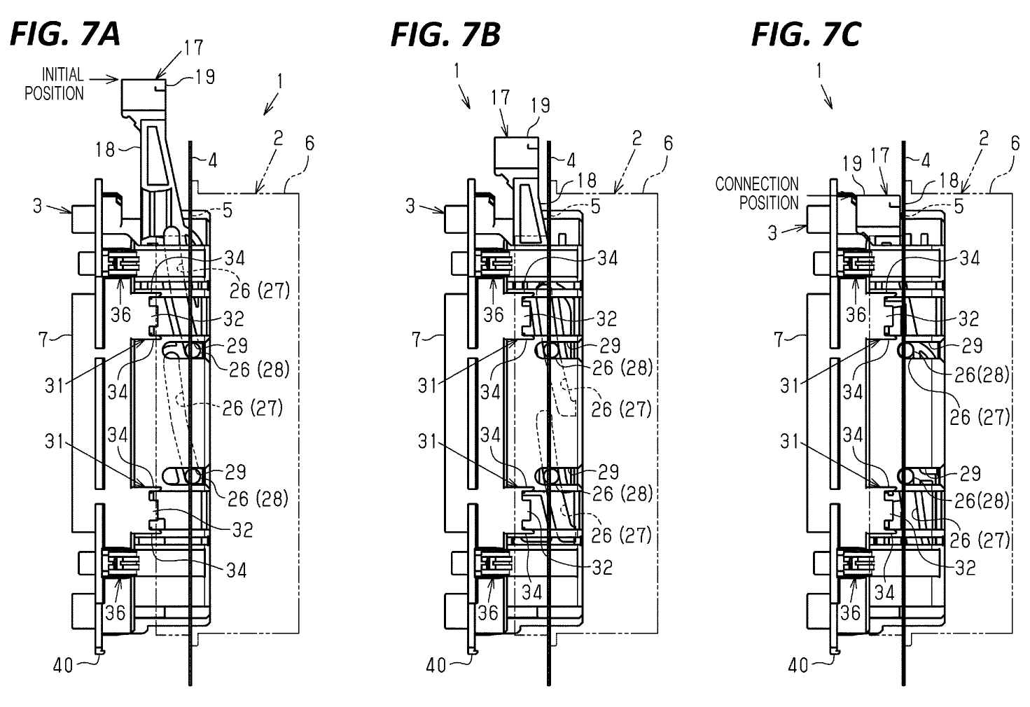

As shown in FIG. 6 and FIGS. 7A to 7C, the panel mount connector 1 is provided with a lever 17 to be operated to completely connect the first and second connector holders 6, 7. The lever 17 includes a pair of arm portions 18 arranged to face each other and a head portion 19 coupling the base ends of the pair of arm portions 18. The pair of arm portions 18 are relatively movably accommodated in lever accommodating portions 20 (only one is shown in FIG. 6) formed in both side parts of the second connector holder 7.

As shown in FIGS. 7A to 7C, the lever 17 is provided on the second connector holder 7 to be operable from an initial position (state shown in FIG. 7A) to a connection position (state of FIG. 7C). The initial position is a position where the lever 17 before an operation is arranged. The connection position is a position where the first and second connector holders 6, 7 are completely connected when the lever 17 operated from the initial position reaches this position. The lever 17 is a so-called slide lever to be linearly operated along a longitudinal direction of the lever 17.

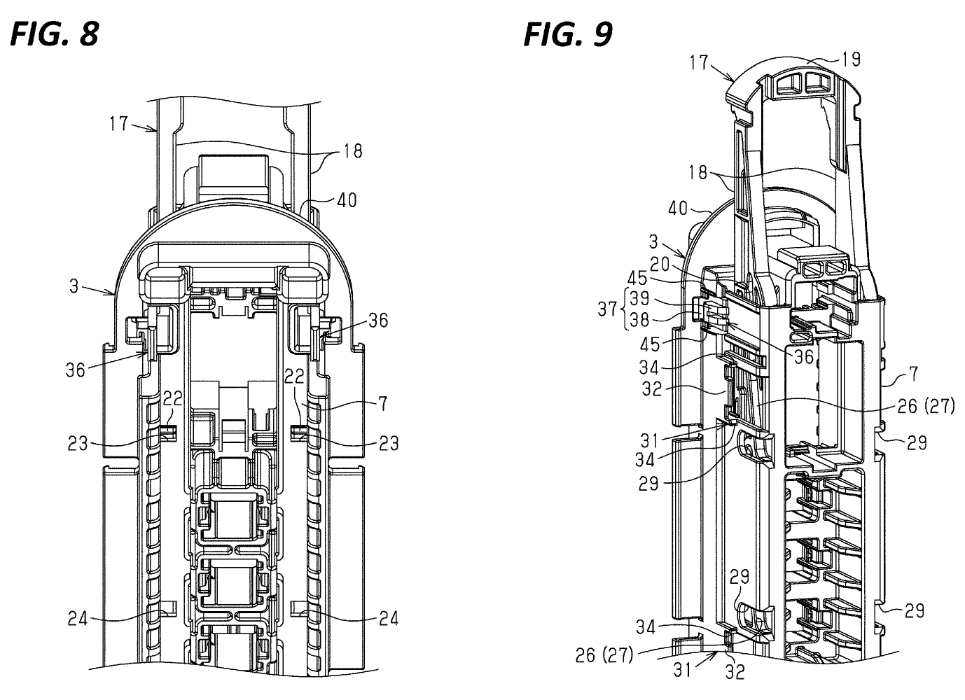

As shown in FIGS. 6 and 8, the lever 17 includes a pair of lever projections 22 formed to be resiliently deformable by forming slits 21 in the respective arm portions 18. As shown in FIG. 8, the second connector holder 7 includes a pair of first recesses 23 to be engaged with the lever projections 22 when the lever 17 is at the initial position and a pair of second recesses 24 to be engaged with the lever projections 22 when the lever 17 is at the connection position. By selectively engaging the lever projections 22 with the first and second recesses 23, 24, the lever 17 is held at the initial position or the connection position.

As shown in FIG. 6, the panel mount connector 1 is provided with cam mechanisms 26 for converting an operation direction of the lever 17 into a fitting direction of fitting the second connector holder 7 to the first connector holder 6. The cam mechanism 26 includes a cam groove 27 formed in a side surface of the arm portion 18 of the lever 17 and a cam pin 28 formed on the inner surface of the first connector holder 6 and to be engaged with the cam groove 27. Two cam grooves 27 are formed in each arm portion 18. The cam groove 27 is, for example, formed along a path inclined to approach the first connector holder 6 in an insertion direction (-X-axis direction of FIG. 6) of the lever 17.

The cam pin 28 is formed into a substantially cylindrical shape to be slidable on the inner surface of the cam pin 27. The cam pin 28 is, for example, arranged on the inner surface of the facing wall 13, 14 constituting the receptacle 11 of the first connector holder 6. Two cam pins 28 are formed on the inner surface of each of the facing walls 13, 14 to be respectively paired with the plurality of cam grooves 27.

As shown in FIG. 9, the second connector holder 7 is formed with window portions 29 enabling the insertion of the cam pins 28 of the first connector holder 6 by exposing the cam grooves 27 of the arm portions 18 accommodated in the lever accommodating portions 20 to outside. Two window portions 29 are formed in each of side walls on both sides of the second connector holder 7 to be respectively paired with the plurality of cam grooves 27.

As shown in FIGS. 7A and 7B, if the lever 17 is pushed from the initial position, a downward operation direction of the lever 17 is converted into a front-rear direction of the second connector holder 7 by the cam pins 28 sliding along the cam grooves 27. In this way, the second connector holder 7 is deeply fit to the first connector holder 6 in the process of operating the lever 17 from the initial position to the connection position. Then, as shown in FIG. 7C, the second connector holder 7 is completely fit to the first connector holder 6 if the lever 17 is pushed to the connection position.

### Releasing Mechanisms 31

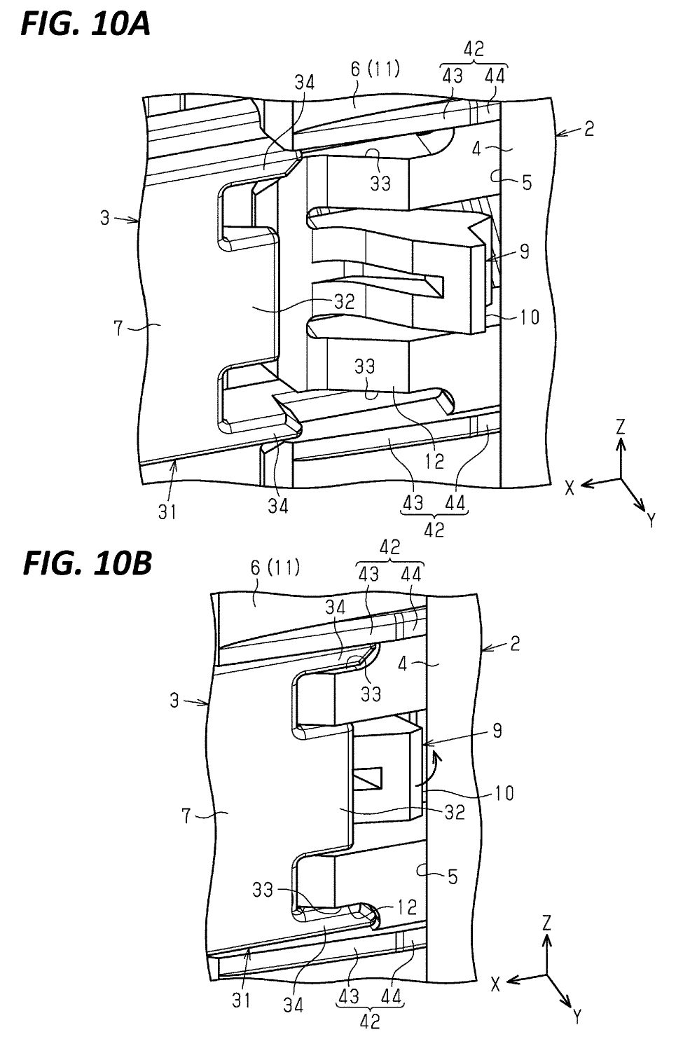

As shown in FIGS. 10A and 10B, the panel mount connector 1 includes releasing mechanisms 31 for releasing the temporary holding mechanisms 9 in the process of fitting the second connector holder 7 to the first connector holder 6. A plurality of (a total of four in this example) the releasing mechanisms 31 are formed to be respectively paired with the temporary holding mechanisms 9 (only one is shown in FIGS. 10A and 10B). The releasing mechanism 31 includes a releasing piece 32 projecting in an insertion direction (-X-axis direction of FIGS. 10A and 10B) of the second connector holder 7. Protrusions 34 for position alignment to be inserted into recesses 33 formed in the first connector holder 6 are formed on both sides of the releasing piece 32.

As shown in FIG. 10A, when the lever 17 is at the initial position, the releasing piece 32 is separated from the temporary holding mechanism 9. Thus, a temporarily held state where the temporary holding projection 10 is locked to the hole portion 5 of the panel 4 is maintained. As shown in FIG. 10B, if the lever 17 is pushed to the connection position and the second connector holder 7 is completely fit to the first connector holder 6, the releasing piece 32 pushes the temporary holding projection 10 of the temporary holding mechanism 9 from front. In this way, the temporary holding projection 10 is located inside the hole portion 5, whereby the locking of the hole portion 5 and the temporary holding projection 10 is released. Thus, the temporarily held state of the first connector holder 6 is released. The releasing piece 32 continues to push the temporary holding projection 10, whereby a state of the first connector holder 6 released from temporary holding is maintained. In this way, the releasing mechanism 31 releases the temporary holding mechanism 9 in the process of completely fitting the second connector holder 7 to the first connector holder 6 in the front-rear direction by a movement of the lever 17 to the connection position.

### Complete Locking Mechanisms 36

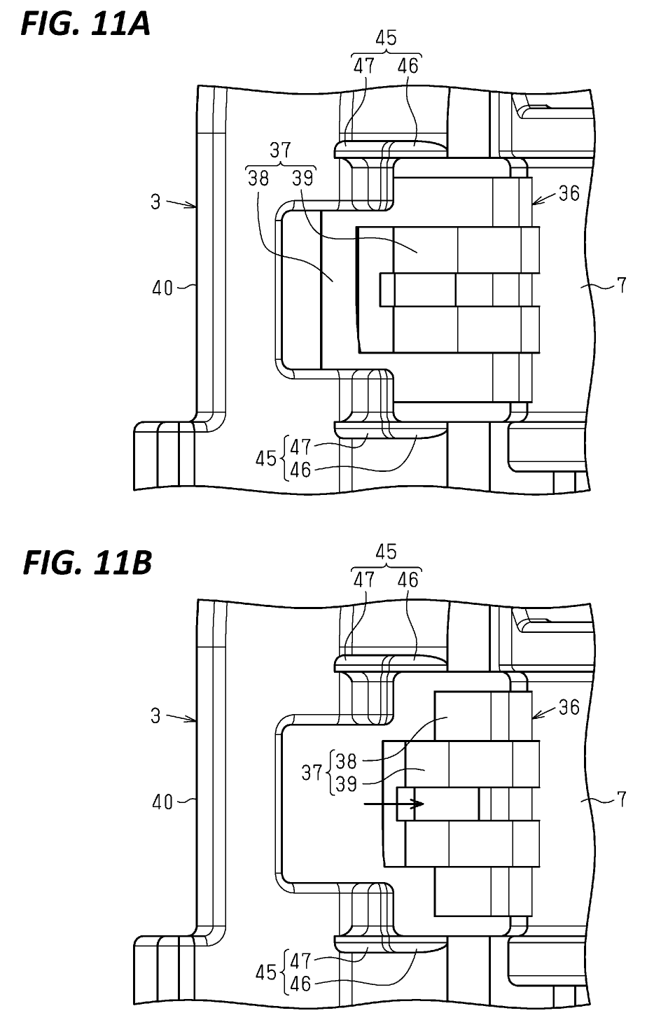

As shown in FIGS. 11A and 11B, the panel mount connector 1 is provided with complete locking mechanisms 36 for completely locking the second connector holder 7 having the first connector holder 6 fit thereto to the panel 4. A plurality of (a total of four in this example) the complete locking mechanisms 36 are formed to be respectively paired with the temporary holding mechanisms 9 (only one is shown in FIGS. 11A and 11B). The complete locking mechanism 36 includes a complete locking projection 37 formed to be resiliently deformable to lock the hole portion 5 of the panel 4. The complete locking projection 37 is for retaining the second connector holder 7 on the panel 4, and shaped to include a projection on the tip of a resiliently deformable arm having a fixed base end. Specifically, the complete locking projection 37 includes a substantially plate-like movable portion 38 to be resiliently deformed with a base end as a center and a claw portion 39 integrally formed to the movable portion 38. As just described, the complete locking projection 37 is formed to be engaged with the panel 4 by a resilient force.

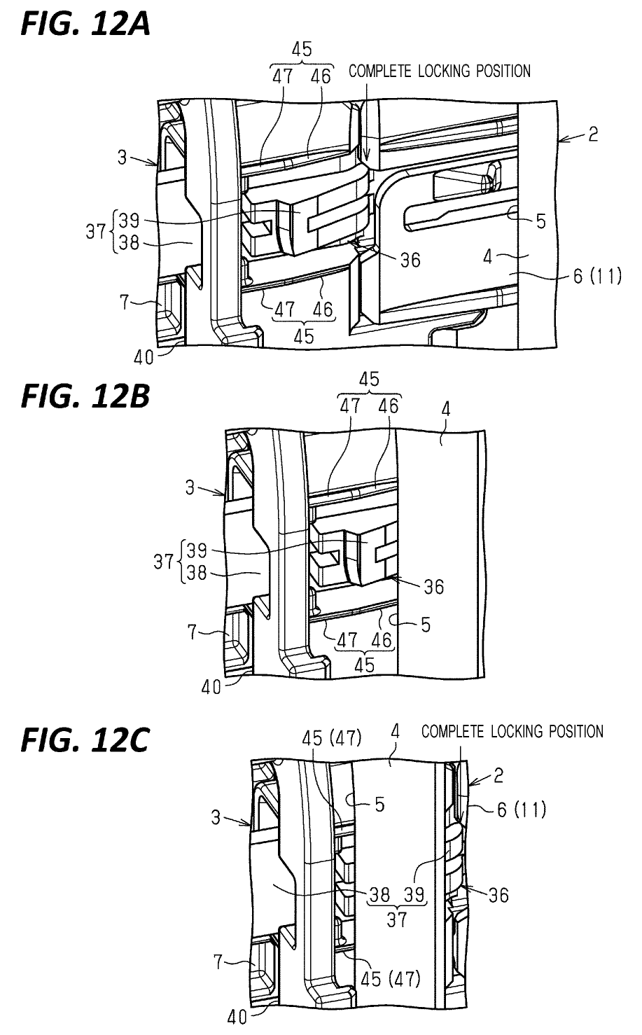

As shown in FIG. 12A, when the second connector holder 7 is pulled toward and completely fit to the first connector holder 6 by the operation of the lever 17 to the connection position, the complete locking mechanism 36 is at a position before complete locking separated from the panel 4 in the second connector holder 7. As shown in FIG. 12B, if the second connector holder 7 at the position before complete locking is pushed to the back by a worker, the claw portion 39 of the complete locking mechanism 36 starts to enter the hole portion 5 of the panel 4. If the second connector holder 7 is pushed to a deepest part as shown in FIG. 12C, the claw portion 39 of the complete locking mechanism 36 is locked to the panel 4.

If the claw portions 39 of the movable portions 38 are locked to the panel 4, the second connector holder 7 is completely locked to the panel 4, instead of the first connector holder 6 temporarily held on the panel 4. In this way, the complete locking mechanisms 36 completely lock the second connector holder 7 in the hole portion 5 of the panel 4 by moving the second connector holder 7 from the position before complete locking to a complete locking position together with the first connector holder 6 released from temporary holding.

A flange 40 for restricting an insertion amount of the second connector holder 7 when the second connector holder 7 is inserted into the hole portion 5 is formed in a circumferential direction on the outer peripheral surface of the second connector holder 7. After the second connector holder 7 is completely locked to the panel 4 by the claw portions 39 of the movable portions 38, any further insertion of the second connector holder 7 is restricted by the interference of the flange 40 with the panel 4 even if the second connector holder 7 is further inserted.

### First Rattling Suppressing Portions 42

As shown in FIGS. 1, 3A and 3B, the temporary holding mechanism 9 includes first rattling suppressing portions 42 for suppressing rattling by being located in a gap between the first connector holder 6 temporarily held in the hole portion 5 of the panel 4 and the hole portion 5. The first rattling suppressing portions 42 are arranged on each of the facing walls 13, 14 located at the opening of the receptacle 11 of the first connector holder 6.

As shown in FIGS. 3A and 3B, the first rattling suppressing portions 42 are arranged near the temporary holding projection 10. Specifically, the first rattling suppressing portions 42 are formed on both sides across the temporary holding projection 10. The first rattling suppressing portion 42 is shaped to extend from the flange 15 of the first connector holder 6 to the tip of the receptacle 11. The first rattling suppressing portion 42 is shaped to be arranged at a position higher than the surface of the base portion 12 supporting the temporary holding projection 10.

The first rattling suppressing portion 42 includes a temporary holding guide slope 43 and a temporary holding contact flat surface 44. The temporary holding guide slope 43 guides the insertion of the first connector holder 6 into the hole portion 5 when the first connector holder 6 is inserted into the hole portion 5 and temporarily held on the panel 4. The temporary holding guide slope 43 is shaped to linearly descend from the temporary holding contact flat surface 44 toward the tip of the receptacle 11.

The temporary holding contact flat surface 44 suppresses rattling between the first connector holder 6 and the hole portion 5 by coming into surface contact with the inner surface of the hole portion 5 when the first connector holder 6 is temporarily held in the hole portion 5 of the panel 4. The temporary holding contact flat surface 44 is, for example, arranged between the flange 15 and the temporary holding guide slope 43 and entirely formed into a planar shape.

### Second Rattling Suppressing Portions 45

As shown in FIGS. 11A and 11B, the complete locking mechanism 36 includes second rattling suppressing portions 45 for suppressing rattling by being located in a gap between the second connector holder 7 completely locked in the hole portion 5 of the panel 4 and the hole portion 5. The second rattling suppressing portions 45 are formed in the side surfaces of the second connector holder 7. The second rattling suppressing portions 45 are arranged near the complete locking projection 37. Specifically, the second rattling suppressing portions 45 are formed on both sides across the complete locking projection 37. The second rattling suppressing portion 45 is shaped to extend from the flange 40 of the second connector holder 7 to the tip of the second connector holder 7. The second rattling suppressing portion 45 is shaped to be arranged at a position higher than the outer wall surface of the second connector holder 7.

The second rattling suppressing portion 45 includes a complete locking guide slope 46 and a complete locking contact flat surface 47. The complete locking guide slope 46 guides the insertion of the second connector holder 7 into the hole portion 5 when the second connector holder 7 fit to the first connector holder 6 is inserted into the hole portion 5 and completely locked to the panel 4. The complete locking guide slope 46 is shaped to linearly descend from the complete locking contact flat surface 47 toward the tip of the second connector holder 7.

The complete locking contact flat surface 47 suppresses rattling between the second connector holder 7 and the hole portion 5 by coming into surface contact with the inner surface of the hole portion 5 when the second connector holder 7 is completely locked in the hole portion 5 of the panel 4. The complete locking contact flat surface 47 is arranged between the flange 40 and the complete locking guide slope 46 and entirely formed into a planar shape.

### Functions of Embodiment

Next, functions of the panel mount connector 1 of this embodiment are described.

### Mounting of First Connector 2 on Panel 4

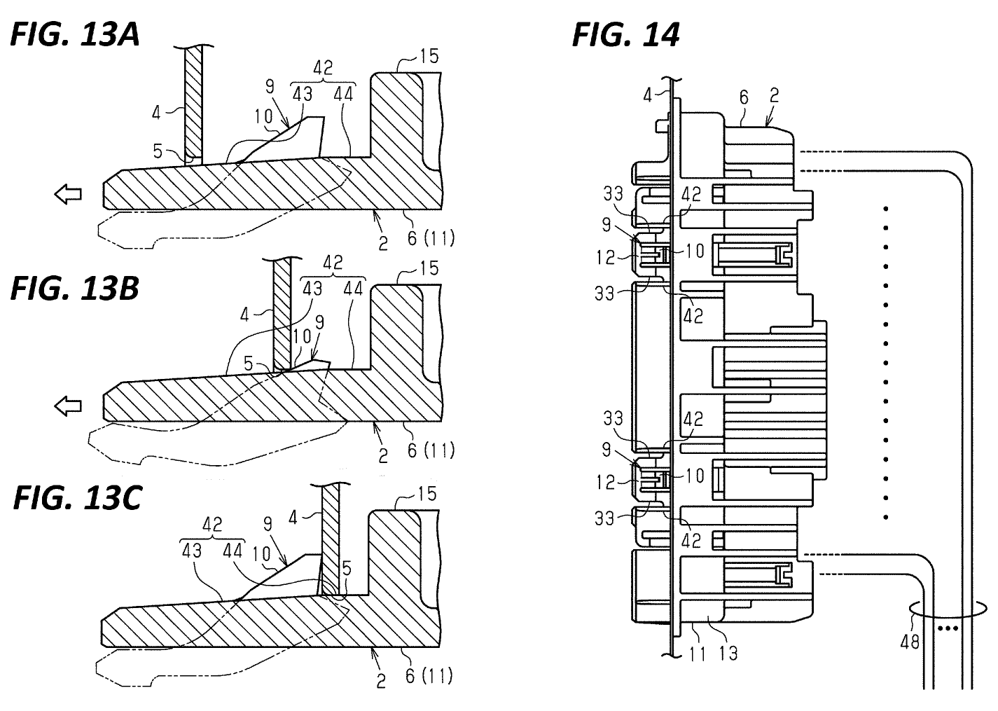

As shown in FIG. 13A, when the panel mount connector 1 is mounted on the panel 4, the receptacle 11 of the first connector holder 6 is first inserted into the hole portion 5. At this time, since the insertion is guided by the temporary holding guide slopes 43 of the first rattling suppressing portions 42, the first connector holder 6 can be smoothly inserted into the hole portion 5.

As shown in FIG. 13B, if the temporary holding projections 10 reach the hole portion 5 of the panel 4 during the insertion of the receptacle 11 of the first connector holder 6 into the hole portion 5 of the panel 4, the temporary holding projections 10 are resiliently deformed by being pushed by an edge part of the hole portion 5. In this way, the insertion of the first connector holder 6 into the receptacle 11 is continued without being affected by the temporary holding projections 10.

As shown in FIG. 13C, if the temporary holding projections 10 ride over the panel 4 in an insertion process of the first connector holder 6 into the receptacle 11, the temporary holding projections 10 resiliently return and are engaged with the panel 4. In this way, the first connector holder 6 is temporarily held on the panel 4 by the temporary holding projections 10. After the first connector holder 6 is temporarily held on the panel 4 by the temporary holding projections 10, the first connector holder 6 may be pulled in a direction opposite to the insertion direction, thereby confirming that the temporary holding projections 10 are properly engaged with the panel 4.

As shown in FIG. 14, the first connector 2 assumes a standby state to wait for the connection of the second connector 3 while being temporarily held on the panel 4. A wire group 48 formed by bundling a plurality of wires extends from the back surface of the first connector 2. When the first connector 2 is in the standby state, the wire group 48 is, for example, bent or pulled to be routed. Thus, an inclined load is applied to the first connector holder 6 temporarily held on the panel 4 in a direction corresponding to a load applied to the wire group 48. For example, if the wire group 48 is bent or pulled downward, the first connector holder 6 is also inclined in that direction. If the first connector holder 6 is kept inclined, it becomes difficult to align the position of the first connector holder 6 with that of the second connector holder 7 and connection workability is deteriorated.

However, since the first connector holder 6 is formed with the first rattling suppressing portions 42 in the case of this embodiment, even if an inclined load is applied to the first connector holder 6 when the first connector holder 6 is temporarily held in the hole portion 5 of the panel 4, the first connector holder 6 can be made difficult to incline in that load direction. Thus, the orientation of the first connector holder 6 is optimized. Accordingly, the second connector holder 7 is more easily aligned in position with the first connector holder 6, wherefore connection workability can be improved.

### Mounting of Second Connector 3 on Panel 4

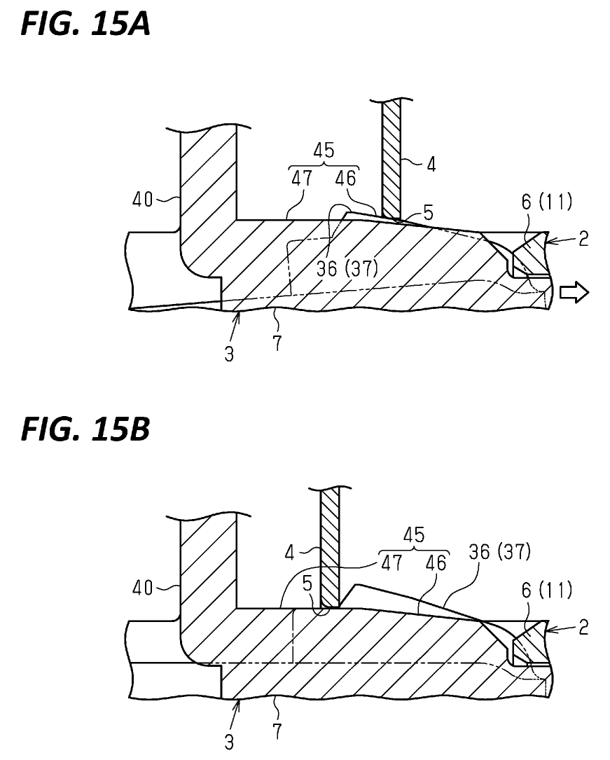

As shown in FIG. 15A, when the second connector holder 7 having the first connector holder 6 fit thereto is inserted into the hole portion 5 of the panel 4, the insertion is guided by the complete locking guide slopes 46 of the second rattling suppressing portions 45, wherefore the second connector holder 7 can be smoothly inserted into the hole portion 5.

As shown in FIG. 15B, if the complete locking projections 37 ride over the panel 4 in the process of inserting the second connector holder 7 into the hole portion 5, the complete locking projections 37 resiliently return and are engaged with the panel 4. In this way, the second connector holder 7 is completely locked to the panel 4 by the complete locking projections 37. In the above way, the panel mount connector 1 is mounted on and fixed to the panel 4.

### Effects of Embodiment

According to the configuration of the above embodiment, the following effects can be obtained.

(1) The panel mount connector 1 is used by mounting the second connector 3 having the first connector 2 connected thereto into the hole portion 5 of the panel 4. The panel mount connector 1 is provided with the temporary holding mechanisms 9, the releasing mechanisms 31 and the complete locking mechanisms 36. The temporary holding mechanisms 9 temporarily hold the first connector holder 6 in the hole portion 5 of the panel 4 before the second connector holder 7 of the second connector 3 is fit to the first connector holder 6 of the first connector 2. The releasing mechanisms 31 release the temporary holding mechanisms 9 in the process of fitting the second connector holder 7 to the first connector holder 6. The complete locking mechanisms 36 completely lock the second connector holder 7 in the hole portion 5 of the panel 4 by moving the second connector holder 7 to the complete locking position together with the first connector holder 6 released from temporary holding.

The temporary holding mechanism 9 includes the first rattling suppressing portions 42 for suppressing rattling by being located in the gap between the first connector holder 6 temporarily held in the hole portion 5 of the panel 4 and the hole portion 5. The complete locking mechanism 36 includes the second rattling suppressing portions 45 for suppressing rattling by being located in the gap between the second connector holder 7 completely locked in the hole portion 5 of the panel 4 and the hole portion 5.

According to this configuration, since it is sufficient to provide the first rattling suppressing portions 42 shaped to fill the gap between the first connector holder 6 temporarily held in the hole portion 5 of the panel 4 and the hole portion 5 of the panel 4, rattling between these can be suppressed by the simply shaped first rattling suppressing portions 42. Thus, the structure of the first connector holder 6 can be simplified. Further, since it is sufficient to provide the second rattling suppressing portions 45 shaped to fill the gap between the second connector holder 7 completely locked in the hole portion 5 of the panel 4 and the hole portion 5 of the panel 4, rattling between these can be suppressed by the simply shaped second rattling suppressing portions 45. Thus, the structure of the second connector holder 7 can also be simplified. In the above way, rattling between the panel mount connector 1 and the panel 4 can be suppressed by the simple configuration.

(2) The panel mount connector 1 is provided with the lever 17 and the cam mechanisms 26. The lever 17 is provided on the second connector holder 7 operably from the initial position to the connection position. The cam mechanisms 26 completely fit the second connector holder 7 to the first connector holder 6 by converting the operation direction of the lever 17 into the fitting direction of the second connector holder 7 in the process of operating the lever 17 from the initial position to the connection position. The releasing mechanisms 31 release the temporary holding mechanisms 9 in the process of completely fitting the second connector holder 7 to the first connector holder 6 by the operation of the lever 17 to the connection position. According to this configuration, the temporary holding mechanisms 9 can be released in conjunction with the complete fitting operation of the first and second connector holders 6, 7 by the lever operation. Therefore, workability can be improved as compared to the case where these are performed by separate operations.

(3) The first rattling suppressing portion 42 has the temporary holding guide slope 43 for guiding the insertion of the first connector holder 6 into the hole portion 5 when the first connector holder 6 is inserted into the hole portion 5 and temporarily held on the panel 4 and the temporary holding contact flat surface 44 for suppressing rattling between the hole portion 5 and the first connector holder 6 by coming into surface contact with the inner surface of the hole portion 5 when the first connector holder 6 is temporarily held in the hole portion 5. According to this configuration, since the insertion is guided by the temporary holding guide slopes 43 of the first rattling suppressing portions 42 when the first connector holder 6 is inserted into the hole portion 5 of the panel 4, the first connector holder 6 can be smoothly mounted on the panel 4. Further, since the first connector holder 6 temporarily held in the hole portion 5 of the panel 4 is supported by the temporary holding contact flat surfaces 44 of the first rattling suppressing portions 42, the first connector holder 6 is held in the hole portion 5 by stable holding forces by the flat surfaces. Therefore, rattling can be made difficult to occur between the first connector holder 6 and the hole portion 5 of the panel 4 by the simply shaped flat surfaces.

(4) The temporary holding mechanism 9 includes the resiliently deformable temporary holding projection 10 for temporarily holding the first connector holder 6 in the hole portion 5 by being engaged with the hole portion 5 of the panel 4 by a resilient force. The first rattling suppressing portions 42 are formed on the both sides across the temporary holding projection 10. According to this configuration, since the first rattling suppressing portions 42 are formed on the both sides across the temporary holding projection 10, the stability of the first connector holder 6 temporarily held in the hole portion 5 of the panel 4 is improved. This further contributes to the rattling suppression of the first connector holder 6 with respect to the panel 4.

(5) The first connector holder 6 includes the receptacle 11 having the outer surface to be held in contact with the hole portion 5 of the panel 4 and configured to accommodate the second connector holder 7 inside. The temporary holding projections 10 and the first rattling suppressing portions 42 are formed in each of the facing walls 13, 14 located at the opening of the receptacle 11. According to this configuration, when the first connector holder 6 is temporarily held in the hole portion 5 of the panel 4, the temporary holding projections 10 are arranged on both sides when viewed from the insertion direction of the first connector holder 6 into the panel 4. Thus, the first connector holder 6 can be held on the panel 4 in a well-balanced manner. Similarly, since the first rattling suppressing portions 42 are also arranged on the both sides, rattling can be suppressed in a well-balanced manner. This further contributes to the rattling suppression of the first connector holder with respect to the panel.

(6) The second rattling suppressing portion 45 has the complete locking guide slope 46 for guiding the insertion of the second connector holder 7 into the hole portion 5 when the second connector holder 7 fit to the first connector holder 6 is inserted into the hole portion 5 and completely locked to the panel 4 and the complete locking contact flat surface 47 for suppressing rattling between the hole portion 5 and the second connector holder 7 by coming into surface contact with the inner surface of the hole portion 5 when the second connector holder 7 is completely locked in the hole portion 5 of the panel 4. According to this configuration, since the insertion is guided by the complete locking guide slopes 46 of the second rattling suppressing portions 45 when the second connector holder 7 fit to the first connector holder 6 is inserted into the hole portion 5 of the panel 4, the second connector holder 7 can be smoothly mounted on the panel 4. Further, since the second connector holder 7 completely locked in the hole portion 5 of the panel 4 is supported by the complete locking contact flat surfaces 47 of the second rattling suppressing portions 45, the second connector holder 7 is held in the hole portion 5 by stable holding forces by the flat surfaces. Therefore, rattling can be made difficult to occur between the second connector holder 7 and the hole portion 5 of the panel 4 by the simply shaped flat surfaces.

(7) The complete locking mechanism 36 includes the resiliently deformable complete locking projection 37 for completely locking the second connector holder 7 in the hole portion 5 by being engaged with the hole portion 5 of the panel 4 by a resilient force. The second rattling suppressing portions 45 are formed on the both sides across the complete locking projection 37. According to this configuration, since the second rattling suppressing portions 45 are formed on the both sides across the complete locking projection 37, the stability of the second connector holder 7 completely locked in the hole portion 5 of the panel 4 is improved. This further contributes to the rattling suppression of the second connector holder 7 with respect to the panel 4.

### Other Embodiments

Note that this embodiment can be modified and carried out as follows. This embodiment and the following modifications can be combined with each other and carried out without technically contradicting.

The first rattling suppressing portions 42 may be formed at positions other than the both sides of the temporary holding mechanism 9 (temporary holding projection 10).

The first rattling suppressing portion 42 may be shaped to have only the flat surface for rattling suppression (temporary holding contact flat surface 44).

The second rattling suppressing portions 45 may be formed at positions other than the both sides of the complete locking mechanism 36 (complete locking projection 37).

The second rattling suppressing portion 45 may be shaped to have only the flat surface for rattling suppression (complete locking contact flat surface 47).

The shapes of the temporary holding projections 10 and the complete locking projections 37 may be changed to various shapes capable of locking the hole portion 5 of the panel 4.

When the second connector holder 7 is fit to the first connector holder 6 in the temporarily held state, hold releasing and complete locking may be simultaneously performed.

The lever 17 may be omitted from the configuration of the panel mount connector 1.

Although the present disclosure has been described with reference to the embodiment, it is understood as not being limited to the embodiment and structures. The present disclosure also encompasses various modifications and modifications within the range of equivalents. In addition, various combinations and forms, as well as other combinations and forms including only one element or more or less elements than that are also within the scope and sprit of concept of the present disclosure.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A panel mount connector to be used by mounting a second connector having a first connector connected thereto into a hole portion of a panel, comprising:
a temporary holding mechanism for temporarily holding a first connector holder in the hole portion of the panel before a second connector holder of the second connector is fit to the first connector holder of the first connector;
a releasing mechanism for releasing the temporary holding mechanism in a process of fitting the second connector holder to the first connector holder; and
a complete locking mechanism for completely locking the second connector holder in the hole portion of the panel by moving the second connector holder to a complete locking position together with the first connector holder released from temporary holding,
the temporary holding mechanism including a first rattling suppressing portion for suppressing rattling by being located in a gap between the first connector holder temporarily held in the hole portion of the panel and the hole portion, and
the complete locking mechanism including a second rattling suppressing portion for suppressing rattling by being located in a gap between the second connector holder completely locked in the hole portion of the panel and the hole portion.

2. The panel mount connector of claim 1, comprising:
a lever provided on the second connector holder operably from an initial position to a connection position; and
a cam mechanism for completely fitting the second connector holder to the first connector holder by converting an operation direction of the lever into a fitting direction of the second connector holder in a process of operating the lever from the initial position to the connection position,
wherein the releasing mechanism releases the temporary holding mechanism in a process of completely fitting the second connector holder to the first connector holder by an operation of the lever to the connection position.

3. The panel mount connector of claim 1, wherein the first rattling suppressing portion has:
a temporary holding guide slope for guiding insertion of the first connector holder into the hole portion when the first connector holder is inserted into the hole portion and temporarily held on the panel; and
a temporary holding contact flat surface for suppressing rattling between the hole portion and the first connector holder by coming into surface contact with an inner surface of the hole portion when the first connector holder is temporarily held in the hole portion of the panel.

4. The panel mount connector of claim 3, wherein:
the temporary holding mechanism includes a resiliently deformable temporary holding projection for temporarily holding the first connector holder in the hole portion by being engaged with the hole portion of the panel by a resilient force, and
the first rattling suppressing portions are formed on both sides across the temporary holding projection.

5. The panel mount connector of claim 4, wherein:
the first connector holder includes a receptacle having an outer surface to be held in contact with the hole portion of the panel, the second connector holder being accommodated inside the receptacle, and
the temporary holding projection and the first rattling suppressing portions are arranged on each of facing walls located at an opening of the receptacle.

6. The panel mount connector of claim 1, wherein the second rattling suppressing portion has:
a complete locking guide slope for guiding insertion of the second connector holder into the hole portion when the second connector holder fit to the first connector holder is inserted into the hole portion and completely locked to the panel; and
a complete locking contact flat surface for suppressing rattling between the hole portion and the second connector holder by coming into surface contact with an inner surface of the hole portion when the second connector holder is completely locked in the hole portion of the panel.

7. The panel mount connector of claim 6, wherein:
the complete locking mechanism includes a resiliently deformable complete locking projection for completely locking the second connector holder in the hole portion by being engaged with the hole portion of the panel by a resilient force, and
the second rattling suppressing portions are formed on both sides across the complete locking projection.
